(19) United States
(12) Patent Application Publication
(10) Pub. No.: US 2005/0091076 A1
(43) Pub. Date: Apr. 28, 2005

(54) Management method

(76) Inventor: Damien McGovern, Middleton (IE)

Correspondence Address: HOVEY WILLIAMS LLP, 2405 Grand, Suite 400, Kansas City, MO, 64108, US

(21) Appl. No.: 10/924,491

(22) Filed: Aug. 24, 2004

Related U.S. Application Data
(63) Continuation-in-part of application No. PCT/IB03/00715, filed on Feb. 26, 2003.
(60) Provisional application No. 60/360,375, filed on Feb. 26, 2002.

(51) Int. Cl. G06F 17/60

(52) U.S. Cl. 705/1

(57) ABSTRACT

Management method providing selected information for taking at least one business decision faster and with less risk, said method using a information treatment system for: receiving information considered juridical; receiving information considered extra modality legal; receiving competitor related information; receiving considered economic and/or commercial said system determining key events and editing selected key events.

This application is a Continuation in Part of PCT/IB03/00715 filed on Feb. 26, 2003, incorporated by reference herein, which claims the benefit of the priority of U.S. Provisional Application No. 60/360,375 filed on Feb. 26, 2002, incorporated by reference herein.

### FIELD OF THE INVENTION

The invention relates to a method suitable for taking business decisions.

### THE PRIOR ART

Up to now, management decisions are taken after drawing up and collating numerous reports, themselves based on numerous and variously constituted business meetings. The usual process results in unnecessary delays in decision making, or else decisions are taken prematurely, without taking into consideration important information, such as information relating to taxes, environment, safety, standards, codes, political changes, etc.

### SUMMARY OF THE INVENTION

The invention relates to a management method providing selected information for taking business decisions more quickly and with less risk, such as a commercial decision, relating to a company or a part thereof or one or more products or services or to one or more groups of products or services, said method comprising the step of using an information treatment system for:
a. receiving information relating to events that are considered juridical;
b. receiving information relating to events considered extra modality legal;
c. receiving information that is competitor event related;
d. receiving information relating to events considered economic and/or commercial
said information treatment system determining and/or selecting from said events one or more key events and/or one or more impact assessments thereof (such as impact task management) and editing said selected event(s) or key event(s) and/or impact assessment(s).

Advantageously, the information treatment system allots a key factor to said key events in function of their importance.

Preferably, the information treatment system receives events with key factors and allots to said key events a key factor.

According to an advantageous embodiment, the information treatment system receives events with a key factor and determines or allots for the key events a key factor in function of their importance, advantageously at least partly in function of the received key factor, and preferably a key factor function at least partly of a received key factor relating to the event and function of one or more computing parameters.

For example, the information treatment system determines from said events, key events and/or one or more impact assessments thereof relating to
one product or family or group of product(s), and/or
one service or family or group of service(s), and/or
one or more companies or family or group of company(ies) or sector of companies.

Advantageously, the information treatment system receives information relating to events about marketing and sales.

Preferably, the information treatment system receives information from all strategy events and news and/or events relating to universals and/or events relating to university and school.

According to a specific embodiment, the information treatment system determines:
the impact or the possible influence of an event that is considered as juridical on at least one event selected from the group consisting of events concerning economic and/or commercial, events relating to extra modality legal, events that are related to one or more competitors, events of market and sales, and all strategy events and news, and/or
the impact or the possible influence of an event concerning marketing and sales on at least one event selected from the group consisting of events considered economic and/or commercial, events considered extra modality legal, events that are related to one or more competitors, events that are considered juridical, and all strategy events and news, and/or
the impact or the possible influence of an event considered extra modality legal on at least one event selected from the group consisting of events concerning economic and/or commercial, events that are related to one or more competitors, events considered juridical, events concerning marketing and sales, and all strategy events and news, and/or
the impact or the possible influence of an event relating to one or more competitors on at least one event selected from the group consisting of events considered economic and/or commercial, events considered extra modality legal, events that are related to one or more competitors, events considered juridical, events concerning marketing and sales, and all strategy events and news, and/or
the impact or the possible influence of an event considered economic and/or commercial on at least one event selected from the group consisting of events considered extra modality legal, events that are related to one or more competitors, events considered juridical, events concerning marketing and sales, and all strategy events and news.

According to a detail of a preferred embodiment, the computer system receives information relating to legal events selected from the group consisting of competition law events, intellectual property events, tax events, health and safety events, company law events, public procurement events, environment events, consumer protection events, free movement events, import/export events, etc.

According to a specific use of the method of the invention, the information treatment system determines one or more sale drivers for one or more products and/or services, and determines advantageously a hierarchy of sales drivers for given products or services or for a selection thereof, for example in one or more given territories, and/or with respect to different competitors for given customer types, etc. Said sale driver(s) is/are determined/suggested by the central computer system in function of one or more key events or impact assessments.

According to another detail of the method of the invention, the central information treatment system receives at least some of said information from one or more peripheral information treatment systems in an electronic, analogic, digital form or signal or in a form adapted to be read and/or converted into an electronic, analogic, digital form or signal or in a translated form or in a form adapted to be translated.

According to a further detail of an embodiment, the central information treatment system determines one or more risk factors associated to one or more key events or impact assessments.

According to a preferred embodiment of the management method, the central information treatment system is linked (linked is used for meaning that the information treatment system comprises one or more databases and/or comprises instruction codes for being able to search and receive data in one or more external databases, such as databases of one or more other computers, said codes enabling for example to retrieve data via internet or intranet or phone net) to at least three groups of data or databases, namely:
a first group of data or first database with data for mapping elements selected from a group selected from the group consisting of products, services, components and combinations thereof, various fields connected to said elements, whereby said fields are defined by at least one reference selected from the group consisting of words, portions thereof, abbreviations, phrases, portions thereof, paragraphs, sections, chapters, compounds thereof and combinations thereof;
a second group of data or database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third group of data or database comprising applicability hooks and the possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof,
   in which the third group is used for linking compliance of the second group relating to at least a portion of a field of an element of the first group, or inversely, so that at least a portion of the reference attached to the linking compliance corresponds substantially to at least a portion of a risk conduit attached to the applicability hook, while at least a portion of the reference attached to the applicability hook corresponds substantially to a reference attached to the field of the element. Possibly the third group can have one or more direct links to one or more compliance.

The word “compound” used here above means that one or more codes and/or operators are used for defining a field of a product, a compliance, a risk conduit, an applicability hook, etc.

Such codes or operators (such as operators for syntax/grammatical set management) are for example:

Comparison Codes:

=: for identical definition
+/−=: for substantially equal definition, same concept, synonym, approximation assessment
<: more precise definition
>: larger definition
#: different definition
etc.
   Operators:
And/or, comprises: for possible alternative definitions comprising at least a specific definition
But not, except: for possible partial covering of a same product
Minus: definition not covering the specific definition
“AND”: combination of two definitions
IF: definition identical for a specific case
etc.

Advantageously, the third group of data or third database is used for determining applicability hook having a risk conduit having a reference corresponding substantially to a reference of another applicability hook.

For example, the first group of data or database incorporates data relating to at least one hooking parameter signalling at least whether a field of an element is attached or linked to at least one applicability hook of the third group of data or database.

According to a detail, the management method comprises the step of adding information in at least one group of data, in at least one of hypothesis selected from the group consisting of:
new mapping field of at least one element;
new compliance;
new risk conduits, and
new applicability hook.

The invention relates also to a computerized machine for implementing partly or substantially completely a management method of the invention. The machine comprises:
means for receiving information relating to events that are considered juridical;
means for receiving information relating to events considered extra modality legal;
means for receiving information that is competitor event related;
means for receiving information relating to events considered economic and/or commercial, and
means for treating said information for determining from said events at least one element selected from the group consisting of key events, impact assessments thereof, and combinations thereof, and editing at least one element selected from the group consisting of events, impact assessments, impact task management and combinations thereof, so as to enable at least one business decision to be taken more quickly and with less risk.

Advantageously, the machine has further at least one means selected from the group consisting of instruction codes for treating at least part of said information, means for reading instruction codes for treating at least part of said information, means for communicating with another machine comprising instruction code for treating at least part of said information, and combination thereof.

Preferably, the machine comprises a central computer information treatment system with instructions for linking at least the three following groups of data, namely:
a first group of data or database with data for mapping elements (i.e. making or defining one or more links between the elements) elected from a group selected from the group consisting of products, services, components and combinations thereof, various fields connected to said elements, whereby said fields are defined by at least one reference selected from the group consisting of words, portions thereof, abbreviations, phrases, portions thereof, paragraphs, sections, chapters, compounds thereof and combinations thereof;
a second group of data or database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third group of data or database comprising applicability hooks and the possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof.

Most preferably, the computer central system comprises:
instruction codes using data of the third group of data or database for linking compliance of the second group relating to at least a portion of a field of an element of the first group, and inversely, said instruction codes being such that at least a portion of the reference attached or linked to the linking compliance corresponds substantially to at least a portion of a risk conduit attached or linked to the applicability hook, while at least a portion of the reference attached to the applicability hook corresponds substantially to a reference attached to the field of the element, and/or
instruction codes using the third group of data or database for determining one or more applicability hooks having a risk conduit having a reference corresponding substantially to a reference of another applicability hook, and/or
instruction codes for incorporating in the first group of data or database, data relating to at least one hooking parameter signalling at least whether a field of an element is attached to at least one applicability hook of the third group or database, and/or
instruction steps of adding or adapting information or data in at least one group of data or database, in at least one of hypothesis selected from the group consisting of:
   new mapping field of at least one element;
   new compliance;
   new risk conduits, and
   new applicability hook.

The central information treatment system uses or has means or instruction codes for defining partly or completely or has means or instruction codes for requiring people (authorized people) to define partly or completely a series of applicability hook tables or matrix(es) for one or more fields for a product/services, and/or for helping people to build new applicability hooks, etc.

The central information treatment system is adapted for emitting one or more requests or information to one or more company departments, such as at least two (preferably at least three) departments selected from the group consisting of board of directors, product management, marketing, sales, corporate planning, purchasing, product development, quality and services, legal and/or regulatory affairs, audit and risk management, etc. For example, when the central information system receives an information about a new law for a product, the central information system determines whether an equivalent law still exist in the compliance data base. If not, a request will be made by the central system to expert(s) for implementing the database with the necessary area of risk conduit.

Preferably, the machine further comprises a means for analysing whether a compliance event entering the machine could have an impact on a data of a database selected from the group consisting of product or mapping database, applicability hook table, and compliance database.

The invention relates also to a machine adapted for the working of the method of the invention.

### BRIEF DESCRIPTION OF THE DRAWINGS

FIG. 1 is a schematic view of a method of the invention,

FIG. 2 is a schematic view of a specific working method of the invention,

FIG. 3 is a schematic view showing a possible mapping for one product,

FIG. 4 is a schematic view of the central treatment system,

FIG. 5 is a schematic view showing working steps of the system of FIG. 4 for an event relating to a product,

FIG. 6 is a view similar to the FIG. 5, but for an event corresponding to an event relating to a specific risk,

FIG. 7 shows schematically a product-mapping matrix.

### DESCRIPTION OF PREFERRED EMBODIMENTS

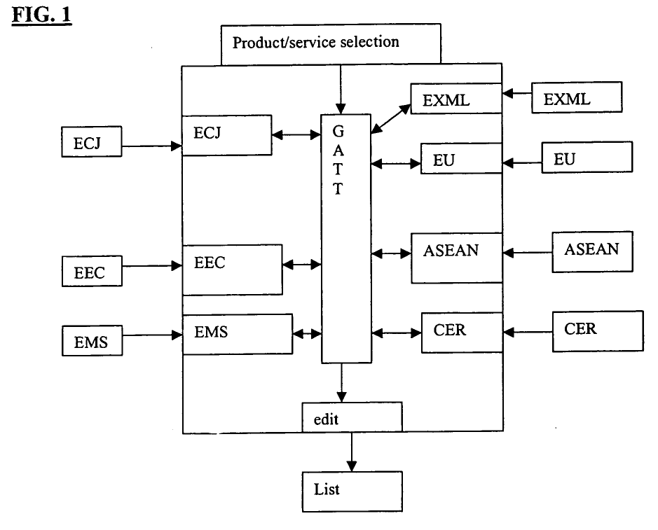

FIG. 1 is a schematic view showing the working of a preferred method of the invention.

The method uses a central computer (CC) connected to a plurality of peripheral computers and/or sending machine, such as fax machines, phones, servers, etc., (CP/SM) the connection between the central computer and the peripheral machines can be made by conductive wires, optical fibres, wireless system, IR connection, radio connection, etc. The central computer is thus provided with instruction codes for being connected to one or more peripheral computers or databases or data providers.

The central computer receives:
information relating to events that are considered juridical (ECJ)

Said information are issuing from the internal legal affairs department(s) of the company/sub company/associated company using the method of the invention and/or from law firms or lawyers or patent attorneys working for said company and/or from official departments, such as patent offices, etc.

Such events are, for example, new regulations, possible amendments of regulations, court decision, potential litigation, status of current litigation, patent status, such as grant, office action, refusal, trademark status, infringement risks, agenda relating to pending cases or to possible cases, etc.

Advantageously, the lawyer/attorney/employee/manager putting in information also allots to the information event for management decision a key factor KF/ECJ.
information relating to events considered extra modality legal (EXML)

Said information are issuing from an internal department of the company/sub company/affiliated company/ etc.

Said information are for example rules adopted by the company/sub company/affiliated company/etc., said rules being not obligatory by law, but for example directed by management choices of the company such as standards, codes, policies, and so on, relating to, for example, ethics, quality, internal control, human rights, voluntary reporting, environmental issues, social affairs, intra company trade, etc, all variously affecting products and processes.

Advantageously, a key factor (KF/EXML) is allotted to said information.

However, as said EXML information is sometimes a constant rule for the company, said key factor can be constant for one or more specific events considered extra modality legal.
information relating to events considered economic and/or commercial (EEC)

Said information are for example issuing from the corporate planning/strategy, commerce oriented departments of the company/sub company/affiliated company. Economics information relates, inter alia, to the effects of compliance choices resulting from events considered juridical (ECJ) and events considered extra modality Legal (EXML) on cost and differentiation strategy, and/or any other positioning strategies.
information relating events that are considered universal (EU).
   said information are for example news provided from journalists, newspapers, TV stations, internet, such as news provided by agencies (Reuters, etc.).
competitor event related information (CER)
   said information relate to events (such as financial, problems, accidents, litigations, growth, new market, products, strategy, etc.) relating to competitors, said competitor being direct competitors and/or potential competitors (such as companies suitable to enter in a competing market or having the knowledge to enter such a market).
all strategy events and news (ASEAN)
   events and news concerning the strategy of the company, such as modification of the strategy decided by the company.
events concerning marketing and sales (EMS)
   such events relate, for example, to the need to reprioritise product sales drivers in a given market, i.e. advertising, price, etc. having normally a sale or market impact.
Risk acceptance (RA)

The company and/or its board decides the types and levels of risk likely to encounter and/or acceptable for the company at any given time. A key factor (KRA) is allotted to risk acceptance in function of the product, its future growth, etc.
Service/product selection (SP/S)

Member(s) of the board of directors having to take a decision can select one or more products/group of products, service/group of services so that the centralized computer can select from the received information the information relating to one or more products or services and/or information having a possible impact on one or more products and/or services.
Globally Applicable Tagging Treatment (GATT)

This centralised treatment system can use a hardware or a software, which can be possibly partly downloaded by internet, from a disc (CD, etc.), or from any support suitable to bear a program or part of a program or data.

Such a treatment system includes a translation system, suitable for translating the received information into one or more selected language, for example for translating at least the selected information into English. Possibly, when the system receives information in languages different from the selected language (SL), the system makes a rough translation (for example only of words, not a syntax translation or a grammatical translation), so as to make a selection of events, news, information relating to one or more products/services, so as to provide a more detailed (such as a full translation) of the received information having a possible impact on the final decision.

The treatment system makes links between the various groups of received information, possibly after a first pre-selection made by the translation system, so as to determine the impact or possible impact/influence of one piece of information on another piece of information, tagging each as appropriate.

The treatment system, even if it receives some key factors, determines or allots key factors to the received information, so that the decision maker can thereafter have a quick view on the most important information having an impact or possible impact on one or more products/services, all of which are tagged appropriately.

The treatment system has an editor (EDIT), so as to edit a list of selected key events or information, preferably with their key factors allotted or confirmed by the treatment system and/or with their possible impact or influence. Editor is defined broadly, i.e. such as providing data in file, such as electronic files, printing, emitting signals suitable for having a view/image/graph/representation of selected key events or information, saving said key events on a support such as an electronic support, sending said key events or information via any means, such as by phone, SMS, fax, e-mil, etc. Said list of key events/information can be edited in any forms, such as in a printable form, in an electronic form (discs, electronic support, form suitable for sending said events/information by fax, by electronic mail, etc.

When the information/events are edited, said information/events are advantageously encrypted by using a secret code or key, so that only authorized people can have access to the edited information/events by means of a decrypting key or code.

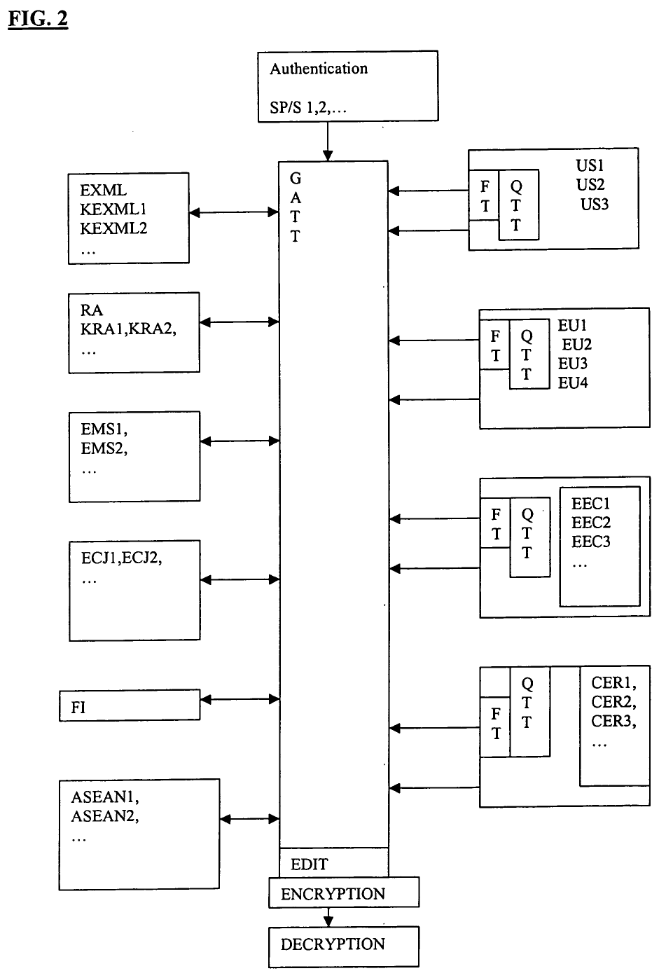

FIG. 2 is a schematic flow sheet showing the working of a method of the invention.

Management level people or people designated by management level people encode in one or more peripheral computer(s) different information relating to the company, such as a multinational company.

These people encode:
EXML (supra legal events or events directed by the politics of the company, and not directed by a law, such events are for example, codes and standards voluntarily complied with, such as advertising or ethics codes or accounting method standards, writing down, valorization of company or participation, etc.) with key factors KEXML1,2, . . . (for example—primordial, preferable, normal, necessary, not absolutely necessary) for each supra legal events/decision
RA (risk accepted by the managing directors, safety, tests to be made, etc.) with their key factors (KRA) (KRA1 for the risk accepted for marketing a product, KRA2 for the risk accepted for the production, etc. (the risk accepted is the level of risk accepted by the company, for example the number of tests to made after the preparation of a product or during its preparation, level of safety protection requested, in case of possible patent litigation, admitted risk level to be condemned, etc.)
EMS1,2, . . . (events concerning marketing and sales, sale drivers, possible influence of sales driver, etc.)
ECJ1,2, . . . (events having a legal impact such as—court decisions, legislation, amendments to legislation, actions of the company having a legal implication, etc.)
Finance of the company (FI)
All Strategy key/news (ASEAN 1,2 . . . such as a strategic decision to focus the company on one or more particular activities, and to disinvest in one or more fields, etc.

All these information are sent to the centralised treatment system.

After due decision of managing director(s) or of the board of directors, instructions can be sent back to said people, by means of fax, electronic mail, or even by the centralized system, etc. so as to modify one or more facts relating to the politics of the company.

The treatment system receives also information from other sources, said information being advantageously filtered by people designated by the company and/or pre-treated (translated partial/complete).

Said information are issuing from peripheral computers and are for example:
EU1,2, . . . , events considered universal, said events being taken from one or more sources, such press agencies, news emanating from official agencies, newspapers, TV, radio, internet provider, etc. As much information is in a foreign language, the information are first quickly translated so as to detect the presence of one or more key words. When one or more pre-selected key words are present in the quickly translated text (QTT), a full translation of the text is carried out, said full translation (FT) being made manually or preferably with computer assistance. The computer detects also the presence of the same information from different source and decide to use both information, for example in case of discrepancy between the sources, or to use only one information (for example information issuing from a privilege source or from a more reliable source).
EEC 1,2,3, . . . events considered economic and/or commercial. A translation system as disclosed for EU is used.
CER1,2,3, . . . events concerning competitors. A translation system as disclosed for EU is used.
events relating to university and school (US1,US2, etc.)
Etc.

The board of directors or specific authorized people can have access to the centralized system with a secret code or key or an authentication system (AUTHENTICATION) so as to enter to the centralized system one or more selected products/services (SP/S1,2, . . . ) for which the treatment system needs to provide a list of key events/information, their possible impact, a key factor, etc.

The treatment system determines from all the received information a list of selected key events/information with possible impacts on decisions to be taken for one or more products/services.

The treatment system edits (EDIT) the list in an encrypted form (ENCRYPTION) (such as in an electronic form sendable by mail, phone, fax, e-mail).

The managing director and authorized people have a secret code/key or authentication system for decrypting (DECRYPTION) the list provided by the centralized system.

The central treatment system (GATT) comprises or has access to different group of data or database.

The first group of data or database (Data1) is suitable for mapping products and/or services in various fields thereof, the latter being defined by at least one reference, such as a word, a portion of word, words, phrases, abbreviations, portion of phrases, paragraphs, sections, chapters, compounds and combinations thereof. Preferably, the mapping is made by use of words, portions thereof and/or abbreviations.

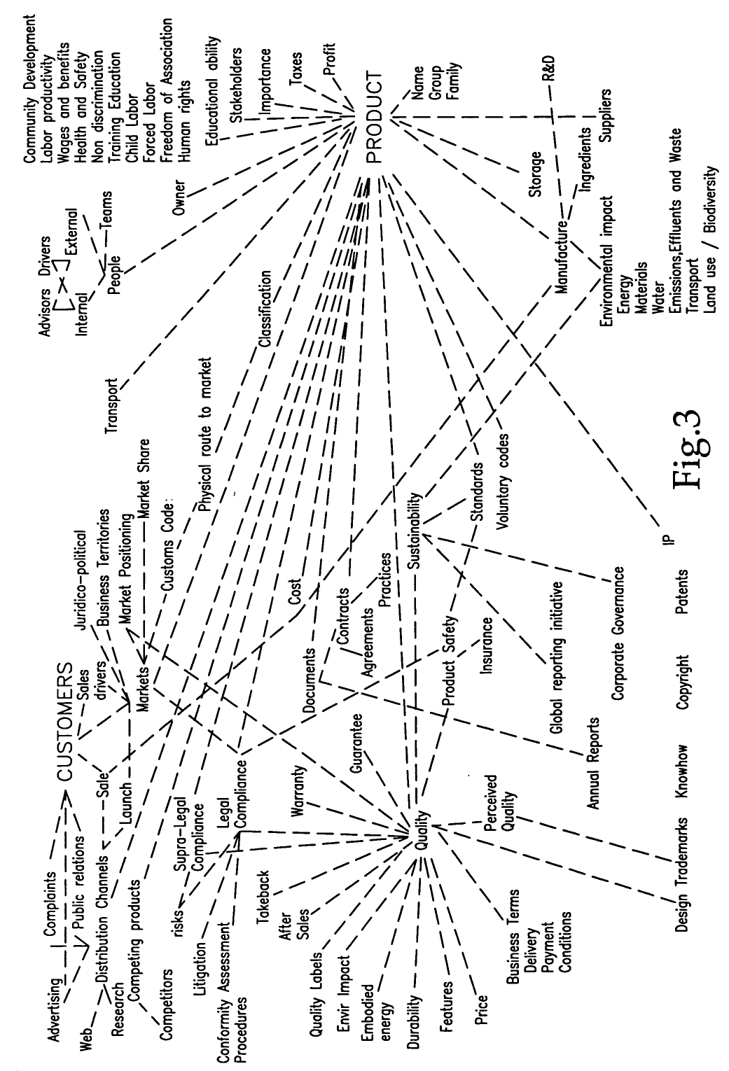

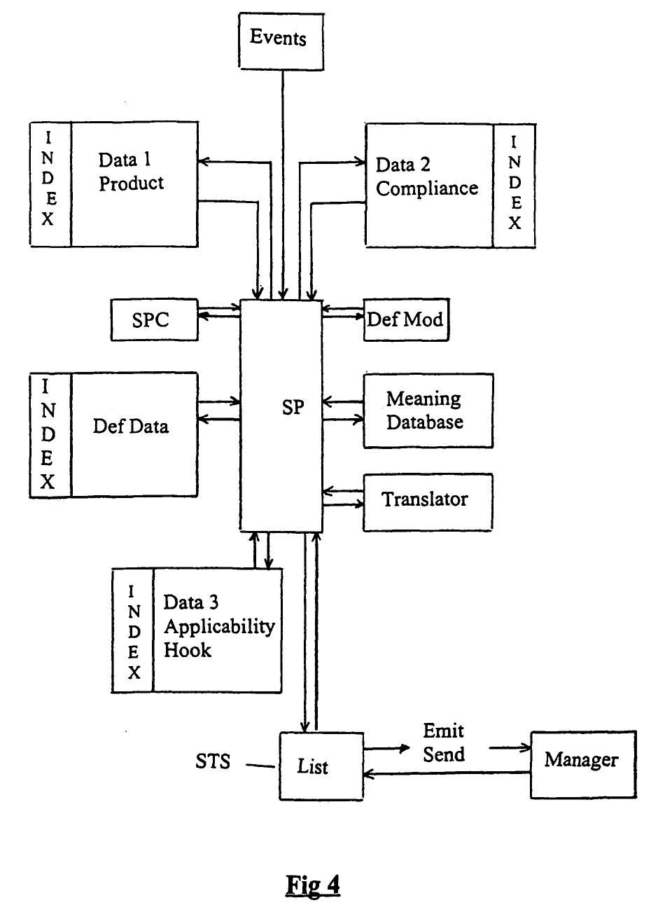

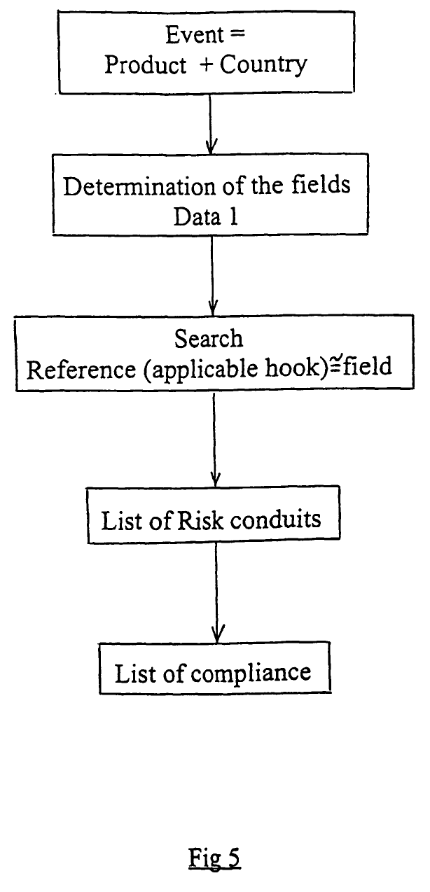

FIG. 3 shows a possible mapping of possible fields for one product. As it can be seen, some fields are directly connected to the product, such as “storage”, “manufacture”, “quality”, etc., while other fields are sub fields of fields directly linked to the product or of sub fields, such as product safety and insurance. Advantageously, the first database Data1 will be provided a time frame so as give variation of definitions or fields of a product or services in function of the time. For example, in case plastic has been used instead of another material, the database Data1 will comprise data so as to know when plastic has been used, i.e. so as to enable the computer system to determine when a compliance is no more effective for the product due to the change of material and/or when another compliance is effective due to said change of material.

In case the definition of field is amended in function of time, the date of amendment will be indicated in the first database, so as to be able to enable the computer system to be able to determine the situation of compliance before the amendment, the situation of compliance after amendment, and preferably the difference of the compliance situation between the situation after amendment and before amendment.

The fields which are able to be connected or linked by means of an applicability hook (which will be disclosed later on) are advantageously marked, for example with a “°”.

The first group of data or database (Data 1) can be put in a form of a matrix or a plurality of matrixes, for example for a group of similar products, etc. The database can also be a combination of various databases, which can be connected therebetween by means of appropriate connections means or computer systems.

The second group of data or database (data2) comprises references to compliance selected from the group consisting of legal decision, laws, rules, directives, guidelines, codes, policies, draft, protocols, supra-legal compliance, supra-legal requirement, standards, etc. Said references are for example a word, a portion of word, words, phrases, abbreviations, portion of phrases, paragraphs, sections, chapters, and combinations thereof. The second database Data2 comprises advantageously a time frame, so that it is possible to quickly now compliance which were effective at or before a date, which will be effective (for example within a time period, such as with a period of 6 months or 1 year), as well so as to determine quickly the period for which the compliance was already effective or the date at which one or more compliance were effective. The second database Data2 comprises advantageously marks or references so as to link one compliance with another, for example so as to make a link between a new compliance with an older one which is no more in force at the moment of the search.

The compliance which are able to be connected by means of an applicability hook (which will be disclosed later on) are advantageously marked, for example with a “°”.

The first group of Data1 or first database is advantageously associated to an index of product, as well as an index of field.

The second group of data (Data 2) or second database can be put in a form of a matrix or a plurality of matrixes, for example for a group of similar compliance, etc., i.e. legal and supra legal compliance in one same field, etc.

The second group of data or database Data2 for the compliance provides advantageously a kind of mapping of each compliance, such as a mapping given for a product. Such mapping will for example gives the area of application, possible exceptions, etc.

The second group of Data 2 is advantageously associated to an index of compliance (law, supra legal, guidelines, codes, policies, draft, protocols, standards, etc.), as well as an index of references (words).

The first and second databases Data 1 and Data 2 are advantageously adapted for making actual linking, past linking, future linking and preferably for specifying the absence of linking.

For example, the Database Data 1 is suitable for mapping products and/or services in various fields in function of the time. For example, the mapping can be done so as to give the actual mapping, a mapping which might be possible, a future mapping, as well as a past mapping.

For example, the Database Data 2 is suitable for referring to compliance(s) in function of the time. For example, the reference to one or more compliance(s) can be done so as to give the actual compliance, compliance(s) which might be possible, future compliance(s), as well as past compliance(s).

The third group of data or database (data3) relates to applicability hooks, said hooks being adapted for linking one or more fields of a product, service, components or group of products or services to one or more compliance of the second group.

The applicability hooks are defined by at least a reference, such as a word, a portion of word, words, phrases, abbreviations, portion of phrases, paragraphs, sections, chapters, and combinations thereof. Preferably, the reference is one or more words, portions thereof and/or abbreviations thereof and/or combinations thereof. The applicability hooks are attached to one or more possible risk conduits, for example to a list of possible risk conduits. The risk conduits are advantageously defined by one or more words, portions thereof, abbreviations, phrases, portions thereof, paragraphs, sections, chapters, and any combinations thereof. Preferably, words, portions of words and abbreviations are used.

The group of Data 3 is advantageously associated to an index of risk conduits, as well as an index of words defining applicability hooks. The database Data 3 is advantageously provided with information or data giving for some applicability hooks, preferably substantially each applicability hook, a list of product (s) to which one or more applicability hooks is pertinent or is of application, a list of product(s) to which one or more applicability hooks might be pertinent or of application, and advantageously a list of product(s) to which the one or more applicability hook will be pertinent or of application in the future. Preferably, the database Data 3 is provided with information or data giving for some applicability hooks, preferably substantially each applicability hook, a list of product (s) to which one or more applicability hooks is not pertinent or is not of application, and advantageously a list of product(s) to which the one or more applicability hook will be not pertinent or not of application in the future. According to an embodiment, the central system is provided with instruction codes enabling to define a date so as to search fields, such as products, possibly affected at said date with one or more applicability hooks. The central system is thus also useful for determining possible risk for the past or for past operations.

Such a database Data 3 is then useful for making very rapid link between one or more applicability hooks and their possible implication on one or more products, now and/or in the future.

The central treatment system is provided with a searching engine or program (comprising instruction codes) (SP) suitable for making links between the databases Data 1 and Data 2, by using the applicability hooks data 3. Advantageously, the central treatment system or the searching engine is provided with a date definition or instruction codes (DateDef) for defining a date, whereby enabling to conduct a search and an analysis at a date or for a period, such as for the past or a period before a date, the actual situation or the today risk analysis, the analysis for the future.

When an applicability hook is used, the searching engine or program (i.e. instruction codes) is also suitable for searching related applicability hook(s) to the applicability hook concerned. For example, in case the first applicability hook has a possible risk conduit “risk conduit A”, and that another applicability hook is defined by a word or phrase comprising or equivalent to “risk conduit A”, said further applicability hook will also be used for searching possible links between the data 1 and the data 2. By means of the third database, the central computer is able to find out all possible links existing between database 1 and database 2, as well as possible links between data of the database 1 and between data of the database 2. For example, assuming the computer is searching compliance for one product, the computer will be provided with a search engine or with instruction codes so as to enable to connect the computer to an appropriate search engine, whereby enabling to find out:
the compliance directly attached or associated to the product,
products which can be considered as substantially equivalent to the product, and the compliance directly attached or associated to the products
family and sector(s) to which belong the product, and the compliance directly attached or associated to said family or sector(s)
components used in the product or during its manufacture, and the compliance directly attached or associated to said components
compliance which can be put in relation with one or more compliance related to a product, sector thereof, components thereof.

A list of compliance will then be edited, with mention of a reference whether the compliance is of application, will be of application or has been of application. In order to limit the analysis, the search engine is provided with instruction codes enabling to define windows, such as areas or country(ies) of the search, type of compliance searched (health, waste recycling, economy, intellectual property, patent, etc.) so as to limit the number of compliance to be edited. The compliance can also then be ranked, for example in function of their level of application, International compliance, regional (such as European) compliance, national compliance, local compliance.

In order to prevent possible misspelling, the search engine or program is connected (for example is provided with instruction codes for enabling a connection to a spelling control system) or is provided with a spelling control system SPC or with spelling control instruction codes (such as an automatic spelling correction system or a spelling system providing several correction options). The search engine is also connected or provided with one or more indexes in order to establish whether two words or phrases are identical or have equivalent meaning or whether a word has a meaning encompassing the meaning of the other words or whether the meaning is different. In case the system is unable to determine whether or not two words have distinct meanings, the system can emit a message to an expert asking him the confirmation whether or not the two words or phrases have different meanings. For making this control of meaning, the search engine is advantageously connected to one or more database with equivalent words or phrases (Meaning database). The searching engine or program can further be provided with an automatic translation system or program (Translator) so as to translate words given in one language into another language, for example when the language used for the compliance definition differs from the language used in the product mapping data base (data 1). Often at least the applicability hook data (data 3) and the group data 1 are established in one single language, such as in English.

The searching program or engine is then able to list a series of possible risk conduits, with specific reference to laws, rules, regulations, etc., especially specific articles thereof.

The central searching system is suitable for making searches, such as complexes searches, in databases relating to one or more ontologies selected from the group consisting of compliance, risks, world, our company, organizations, people, activity system, tasks, resources, definitions matrix, and combinations thereof. These databases could be one or more data bases different from the database Data1 (product mapping) and the compliance database (Data2).

Advantageously, however, the mapping product database (data1) will give information on at least ontologies selected from the group consisting of compliance, risks, world, our company, organizations, people, activity system, tasks, resources, definitions matrix, and combinations thereof. Preferably, substantially all said ontologies will be linked in the product mapping database.

The complex search enables the system to find out the responsible for some products, the responsibility or tasks attached to one people or department, the resource available for this project, etc.

As complex search is possible, the possible modification of some data in one or more databases can possibly be made automatically (for example for replacing the responsibility from one department to another, etc.) or after and/or with skill expert.

The central treatment system can be used in various ways. Some of the possible working ways are disclosed hereafter as example only.

First Way—Product Directed (FIG. 5)

Auditors (in house or outside of the company) and/or member(s) of the board of directors and/or a product manager want to determine the risk level for a product sold by the company in one specific country or region(s) within a country or a group of countries or the world.

The product and countries will be entered as events in the searching engine or program, whereby the searching engine or program will determine from the first database (Data1) the relevant fields, as well as sub-fields for the product in the considered country. After determining the fields and sub-fields considered for the product, the search engine will make a list of fields and subfields not linked to one applicability hook, as well as a list of fields and sub-fields connected or linked to one or more applicability hooks (marked fields).

The central treatment system determines then a list of applicability hooks which have a reference (word or words) identical or equivalent or comprising the marked fields. From the applicable applicability hooks, the searching program determines a list of conduit risks in the second database Data2 and further searches whether for one or more specific conduit risks, specific applicability hooks exist for the country(ies) considered or region(s) or territories, etc.

The searching engine determines then in the compliance data (data 2) the compliance having as reference a word or words corresponding or equivalent to the word or words of the list of risk conduits of the determined applicability hooks, and determines the list of compliance which are of interest in the selected country, countries, region, etc.

The searching engine will then further check whether a risk has already been quoted or evaluated to zero in the mapping database 1, so as to delete from the list of risks one or several risks already considered as not present. Possibly the deleted risk can be indicated into brackets, for a possible further check.

The risk conduits can also be quoted (for example said quotation can be part of the information of the applicability hook), in order to show the level of risk and/or the type of risk. The auditors and/or manager or directors can then have a quick view on the possible risks for the product, and can further quickly determine where to search further information for quoting or evaluating more accurately the type and level of risk.

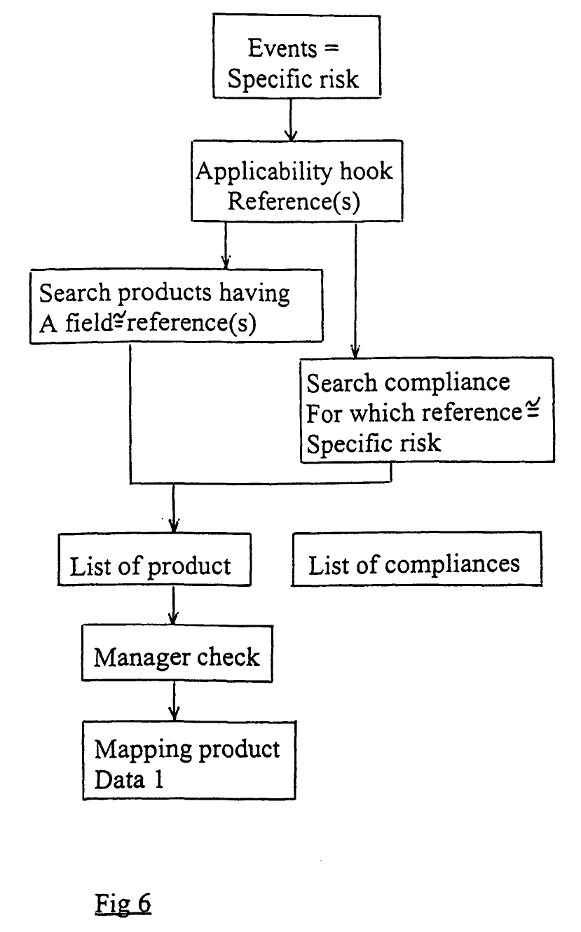

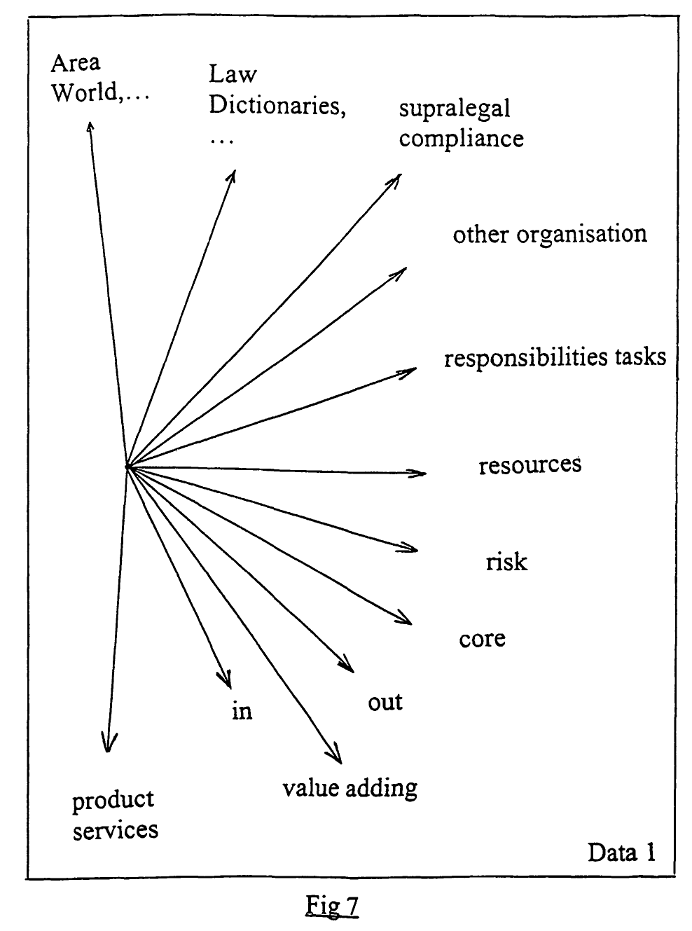

Second Way—Risk Directed (FIG. 6)

Auditors/director/manager wanting to know whether a specific risk conduit exists in a country will enter as events in the searching engine: the risk conduit A and the country.

The searching engine will determine the applicability hook connected directly or indirectly to the risk conduit A. After determining the list of applicability hooks, the system will determine the list of products having a field that can be affected by the risk of conduit A, as well as the compliance corresponding to said risk conduit. The central system will limit the possibly affected products to the product marketed or manufactured or any other links to the country considered.

A list of products will so be established by the system, with a list of possible compliance of interest. Possibly, in case the risks are already mapped in the database 1, said risks will also be listed with their quotes or level. The computer will for example edit said list by ranking the products in function of their sale (actual sale and/or projected sale), or in function of one or more parameters, etc.

Said list will then be mailed (for example by e-mail) or faxed to the product manager(s) in order to receive a reply whether or not said risk conduit A exist for one or more products.

The data communicated by said product manager(s) (after a possible expert check) can then be encoded in the product mapping so as to avoid to have a further request and so as to have a quicker risk evaluation. Advantageously, the data will be encoded with a date at which the product manager and/or the expert have checked the risk conduit A, so that in case the lack of risk conduit A was analysed more than one year ago, a new request can be sent to the product manager(s) in order to receive a reply whether or not said risk conduit A exist for one or more products. For making possible modification to one database, the searching engine is provided with data modification instructions for enabling a modification or an addition of data to the database 1. For this purpose, the list of possible affected products are stored in a sub treatment system STS which emit said list to product manager(s) and which collect the results or comments of the manager(s), and which, automatically or possibly with an manual expert instruction, is suitable for sending a back information to the central system or program for adding information in the risk field for the product for which no risk was evaluated.

Third Way—Compliance Directed

Assuming a manager or director wants to determine the products affected by a compliance event, he will enter as event the “compliance” to be analysed. From said compliance, the central system will find out the applicability hooks having a risk conduit equal or substantially equal to one or more references terms or words of the compliance. Knowing the applicability hooks, the system will find in the database Data 1 the products having a field corresponding to the reference of one or more selected applicability hooks.

Fourth Way—New Product

If a new product is entered in the system as event, the system will first search, possibly with human/expert intervention, such as intervention of the product manager, whether a similar product is already encode in the mapping product database (database 1).

In case, on basis of information provided by the product manager, the system determines that a similar product is already mapped, the new product will be considered as having the same fields as the product already encoded, except for some particularities, such as possible market, possible manufacture, etc.

In case the product is completely new in the database, a mapping of the product has to be encoded on basis of the information received by the product manager. When for existing fields of the database 1, hooking marks are identified, the fields similar to said existing fields will also be marked so as to enable a hooking of an applicability hook.

The central system will then be activated in order to determine all possible risk conduits and the list of all applicable compliance. Said lists will be analysed in order to enter data in the mapping database 1, so as to avoid one or more hooking for one or more fields (no mark in some fields) or so as to specify directly that one or more risks in the mapping database 1 is null.

Fifth Way—New Compliance

In case a new compliance is entered as event in the system, it is first necessary to request from an expert to specify possible risk conduits and/or applicability hook(s). This assessment requires skill. Advantageously, the searching program will comprise instructions for proposing automatically possible risk conduits and/or possible applicability hooks, the expert having then to select one or more of the possible alternatives, and/or for helping an expert to build correctly risk conduits and/or applicability hooks. The searching program will for example propose wording already used in the system or present in the risk conduit database or in the applicability hooks database.

The central system will then determine a series of existing compliance in the database Data2 that have one or more of the same possible conduit risks. If a compliance having the same conduit risk is already present in the database, an expert will have only to encode that the new compliance corresponds to an already encoded compliance with one or more particularities.

If a new compliance is intended to replace an older one, an expert will have to adapt one or more risk conduits of the older compliance.

If the compliance is completely new, an expert will have to enter some possible risk conduits. Thereafter, the system will work so as to determine other compliances having the entered risk conduits. The system will then edit a list of possible risk conduits from the other compliances. The expert will then confirm or delete one or more risk conduits from the list, in function of the fact that said risk conduits are not applicable to the new compliance.

The mapping product database can have the form of a definition matrix (data1), which contains various definitions of wordings, products, services, components, components, etc. in function of the laws (such as laws applicable for the countries where a product is marketed or a service is furnished, national laws, regional laws, European laws, international laws, directives, commission), standards (national, international), guidelines, codes, policies, draft, protocols, dictionaries (general, specialized), court decision, supra legal definition, ethical definitions, etc. When the products or services use many different components or services or processes, links are made to sub-laws, standards, etc. and/or to sub definitions and/or to risk conduit definitions. The data definition matrix can also contain quote for ranking the definition or products or services in function of their importance. The products or services are so analysed in view of their environment aspect, their consumer protection aspect, the company law aspect, the product safety aspect, the taxation aspect, etc.

In order to facilitate the use of the database of the product and/or the compliance database and/or one or more index files, codes are used so as to make a comparison with respect to one or more specific definitions, for example product definitions, a referenced product, a law or compliance of reference. Such codes or operators (such as operators for syntax/grammatical set management) are for example:

Comparison Codes:

=: for identical definition
+/−=: for substantially equal definition, same concept, synonym, approximation assessment
<: more precise definition
>: larger definition
#: different definition
etc.
   Operators
And/or, comprises: for possible alternative definitions comprising at least a specific definition
But not, except: for possible partial covering of a same product
minus: definition not covering the specific definition
“AND”: combination of two definitions
IF: definition identical for a specific case
etc.

The compliance database (data 2) comprises advantageously information on the compliance having the largest requirement or risk or consequence for one or more risk conduits in a group of countries or in the world.

The product-mapping database can also contain the largest definition of a product, service, components, etc. respectively according to laws, the standards, etc., and/or according to the market or possible market.

This can be advantageous in order to take immediate decision, i.e., a decision taking into account a risk evaluation covering the broadest possible definition of a product, service, components, etc.

The product mapping database can comprise information about a plurality of possible fields, such as compliance, various parameters, brand image, competition & prices, features, price, warranties, promotions, advertising, installation, perceived quality, advice, customer training, quality of pre-sale advice, after sale advice, sales experiences, etc.

The product mapping database will also advantageously comprises a level of importance of the product for the company (for example, a high level will be allotted to products with high revenue or potentially high revenue).

The central treatment system can be provided with computer instructions for emitting at least a signal requiring whether or not the applicability hook has to be amended (for example by amending a risk level allotted to a risk conduit) and/or whether a new field of the database 1 has to marked as being possibly associated to an applicability hook (status of a product in development to a status of a marketed product) and/or whether a compliance has to be marked as possibly associated to an applicability hook (for example, a compliance is first indicated in the database 2 as a draft of compliance and/or a compliance entering in force at a certain date, and is thereafter marked as compliance in force or soon in force).

The treatment system can be a machine comprising instruction codes for making the appropriate treatment of the information or part thereof and/or comprising means suitable to read (store, install, etc.) instruction code (stored on an electronic support, provided from another computer or server) for making the appropriate treatment or part thereof and/or means for communicating with another computer comprising instruction code, so that said other computer carries out the appropriate treatment or part thereof.

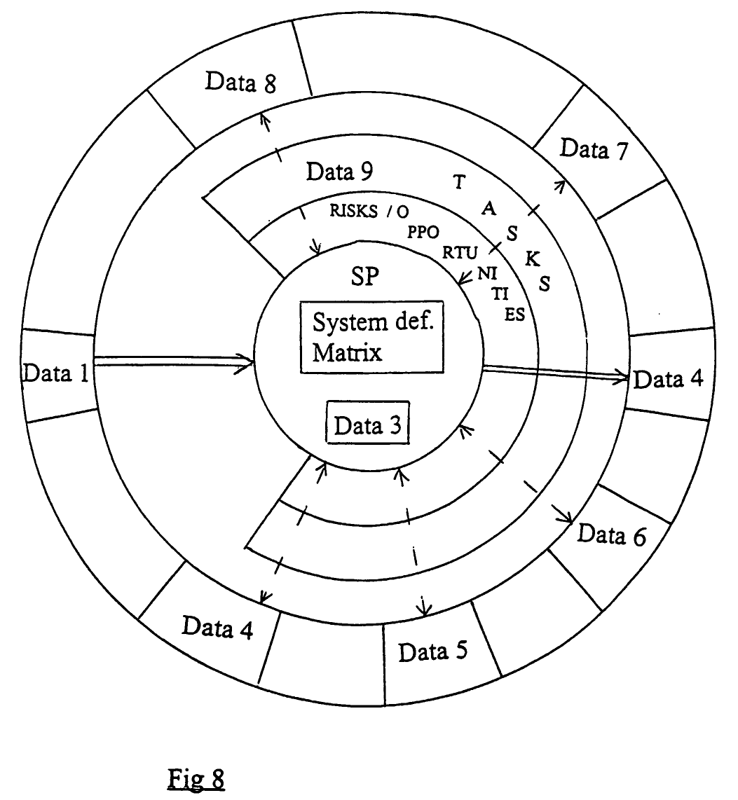

Most preferably, the database 1 is a multi entry matrix [product; area; product/services/activities (in; value added; out; core); law; compliance policy area; risk level; responsibility; tasks; resources; people; company; organisations; definitions; etc.]. (See FIG. 7, each direction defines a field extension of the matrix.) Cases of the matrix can be regrouped in one single case, when a same definition of the product is given and when legal provisions are the same or quite equivalent. All possible entries or parameters of the database or matrix will be defined by a name or names, words, phrases, etc.

The central treatment system can also be provided with a database (Defdata) comprising definitions of words, such as products, services, components, components, etc., such as definition given or used in laws, directives, guidelines, codes, policies, draft, protocols, dictionaries, special dictionaries, industry terms, own company terms, case law, agreements, other sources, as well information about the largest definition and/or information about the similarity between two definitions, or between a definition and a reference definition. Said database is connected to a index of defined words.

The product/service/activity database (data1) comprises information on fields connected to what is coming in the company for one or more products/services (IN), fields connected to the added value in the company (Value Adding), fields on what is going out of the company (OUT), and fields relating to the core of the company (Core).

The following table gives examples of possible fields for a product/service/activity

| IN | VALUE ADDING | OUT |
|---|---|---|
| Human Resources | Human Resources | Human Resources |
| Financial Resources | R&D/Innovation | Financial Resources |
| Fixed Assets | Production | Product |
| Intellectual Capital | Process Monitoring | Outbound Logistics |
| Goods Inwards | Packaging | Post-Sale Service |
| Inbound Shipment | Internal Logistics | Marketing |
| Services Inwards | Branding | Requests/Queries |
| Sales Orders | | Intellectual Capital |
| Information Requests | | |

CORE RESOURCES/ACTIVITIES

| | | |
|---|---|---|
| Accounting/Finance | Management | Planning & Strategy |
| Administration | Legal Affairs | Firm Architecture |
| IT | Internal Auditing | |

The applicability hook database is advantageously built so as to be able to classify the type of risk conduits. A specific code is for example allotted to risk conduits in function of their most probable type of risk, such as financial or business risk, legal risk, damage type risk, risk opportunity, etc.

The product-mapping database Data 1 is provided with a field concerning to the responsibilities in the company, for example people responsible for this kind of problems or for this product. This is made by defining the structure of the group, of the department and of the people.

Advantageously the central treatment system is advantageously provided with a general index of words, abbreviations, etc. used in the system SP. The system can therefore emit a message, when a word put as event is not present in the index or a portion of the general index, as such or as equivalent wording. The system or engine SP will possibly emit a list of words considered as equivalent or having a spelling very similar to the word defining the event. An expert can then select from said list one or more words he considers as having equivalent meaning.

The central system or the searching engine is advantageously provided with a means “def mod” for analysing whether an event entering the system could have an impact on one or more definitions or fields of one or more databases. In case the event has an equivalent meaning of a word already present in the database, the means Def Mod is suitable for making automatic insertion of said event as new word in the index with a code identifying the relation with one or more words already present in the index.

When one or more databases do not contain an information, a field or a data for one or more possible events, said event will be coded so as to edit the lack of information when said event can be a part of the impact task management to be done by the auditor(s) or member(s) of the board of directors. For example the absence of possible hooking is advantageously identified, in order to enable to edit a list of possible fields that have not been related to a conduit risk.

In order to save time, a first impact task management can be first made by the central system without modification of possible definition/applicability hooks/risk conduits (automatic and/or via expert), and then a second impact task management is made taking into account the expert's input on possible definition/applicability hooks/risk conduit modification or the automatic modification. This could be of interest in order to check the correct working of the system and/or to better determine the importance of an event or a possible modification of possible definition/applicability hook/risk conduits.

When having these two impact task managements, the impact modification is even much clearer for the board of director and/or for product manager and/or for auditors and/or for risk management.

The central system edits a list of questions towards responsible people or product managers for obtaining back information on the possible risk management for one or more products/services. Said information is automatically encoded in the data matrix MA, except if the Responsible people/product manager emits a reply with a code stating “no reply given” or “reply requires other/further analysis”.

A final impact task management can then be emitted for the responsible peoples of the company, in order to facilitate them to take a decision.

One or more databases or group of data could be not present in the central system as. In this instance the central system will be provided with means for communicating (emitting towards and receiving) information with outside database. The communication can be made via wires, e-mail, phones, etc.

FIG. 8 is a further possible mapping of the working of a system of the invention. The central system with the search program SP has access to a system definition matrix and to a group of data connecting applicability hook with risk conduit (Data3).

The central system is linked (for example by wires, internet, etc.) to various ontologies databases, namely for compliance (Data1), for product (data2), for the world (data 4), for the company (data 5), for the people (data6), for organization (data 7), for resources (data8), for tasks (data9), for risk opportunities (data 10).

The central system SP, when it cannot directly link a compliance event with a product, it will make a search in one other database (database 4 to 9) in order to find out a reply (automatic or via human skill expert (for example via the task database)) how to make a link or whether no link exists. The central system will then determine the risk opportunities for the product.

1. A management method providing selected information for taking at least one business decision faster and with less risk, relating to a company or a part thereof or one or more products or services or to one or more groups of products or services, said method comprising the step of using a at least partly computerized information treatment system for:
a. receiving information relating to events that are considered juridical;
b. receiving information relating to events considered extra modality legal;
c. receiving information that is competitor event related;
d. receiving information relating to events considered economic and/or commercial
whereby at least some events are key events,
said information treatment system determining from said events at least one key event and editing said key event.

2. The management method of claim 1, in which said information treatment system determines and selects from said events several key events and edits said selected key events.

3. The management method of claim 1, in which at least one impact assessment is related to at least one event, whereby the information treatment determines from said events at least one impact assessment and edits at least said impact assessment.

4. The management method of claim 1, in which several impact assessments are related to events, whereby the information treatment system determines from said events a plurality of impact assessments and edits said plurality of impact assessments.

5. The management method of claim 1, in which several impact assessments are related to events, whereby the information treatment system determines from said events at least one key event and at least one impact assessment related to said key event, and whereby the information treatment system edits said key event and at least one impact assessment related to said key event.

6. The management method of claim 1, in which said information treatment system determines and selects from said events several key events with different importance, and in which the information treatment system allots a key factor to said key events in function of their importance.

7. The management method of claim 1, in which the information treatment system receives key factors relating to events and allots to the selected key event a key factor function at least partly of the received key factor for said key event.

8. The management method of claim 1, in which the information treatment system receives key factors relating to events, determines and selects several key events, and determines for at least one selected key event, a key factor in function of at least the received key factor relating to the event and in function of computing parameters.

9. The management method of claim 1, in which the information treatment system determines from said events at least one key event relating to an element selected from the group consisting of products and families of product.

10. The management method of claim 1, in which the information treatment system determines from said events at least one key event relating to an element selected from the group consisting of services and families of services.

11. The management method of claim 1, in which the information treatment system determines from said events at least one key event relating to an element selected from the group consisting of companies and sectors of companies.

12. The management method of claim 1, in which the information treatment system receives information relating to events concerning marketing and sales.

13. The management method of claim 1, in which the information treatment system receives information from all strategy events and news.

14. The management method of claim 1, in which the information treatment system receives information relating to events selected from the group consisting of universal events, events relating to university, and events relating to school.

15. The management method of claim 1, in which the information treatment system determines an impact of at least one event that is considered as juridical on at least one event selected from the group consisting of events considered economic, events considered commercial, events considered extra modality legal, events that are related to at least one competitor, events concerning marketing and sales, and all strategy events and news.

16. The management method of claim 1, in which the information treatment system determines a factor selected from the group consisting of impacts of an event concerning marketing and sales and possible influences of an event concerning marketing and sales, on at least one event selected from the group consisting of events considered economic, events considered as commercial, events considered extra modality legal, events that are related to one or more competitors, events considered juridical, all strategy events and news.

17. Management method of claim 1, in which the information treatment system determines a factor selected from the group consisting of impacts and possible influences of an event considered extra modality legal on at least one event selected from the group consisting of events considered economic, events considered commercial, events that are related to at least one competitor, events considered juridical, events concerning marketing and sales, all strategy events and news.

18. The management method of claim 1, in which the information treatment system determines a factor selected from the group consisting of impacts and possible influences of an event relating to at least one competitor on at least one event selected from the group consisting of events considered economic, events considered commercial, events considered extra modality legal, events that are related to at least one competitor, events considered juridical, events concerning marketing and sales, all strategy events and news.

19. The management method of claim 1, in which the information treatment system determines a factor selected from the group consisting of impacts and possible influences of an event considered economic on at least one event selected from the group consisting of events considered extra modality legal, events that are related to at least one competitor, events considered juridical, events concerning marketing and sales, and all strategy events and news.

20. The management method of claim 1, in which the information treatment system determines a factor selected from the group consisting of impacts and possible influences of an event considered commercial on at least one event selected from the group consisting of events considered extra modality legal, events that are related to at least one competitor, events considered juridical, events concerning marketing and sales, and all strategy events and news.

21. The management method of claim 1, in which the computer system receives information relating to legal events selected from the group consisting of competition law events, intellectual property events, tax events, health and safety events, company law events, public procurement events, environment events, consumer protection events, free movement events, import/export events.

22. The management method of claim 1, in which the information treatment system determines at least one sale driver for at least one product.

23. The management method of claim 1, in which the information treatment system determines a plurality of sale drivers for at least one product and determine a hierarchy of said sale drivers.

24. The management method of claim 1, in which the information treatment system determines at least one sale driver for at least one service.

25. The management method of claim 1, in which the information treatment system determines a plurality of sale drivers for at least one service and determine a hierarchy of said sale drivers.

26. The management method of claim 1, in which the central information treatment system receives at least some of said information from at least one peripheral information treatment system in a form selected from the group consisting of electronic form, analogic form, digital form, form adapted to be read into an electronic form, form adapted to be read in an analogic form, form adapted to be read in a digital form, form adapted to be converted into an electronic form, form adapted to be converted in an analogic form, form adapted to be converted in a digital form, translated form and form adapted to be translated.

27. The management method of claim 1, in which the central information treatment system determines at least one risk factor associated to at least one key event.

28. A management method providing selected information for taking at least one business decision faster and with less risk, relating to a company or a part thereof or one or more products or services or to one or more groups of products or services, said method comprising the step of using a at least partly computerized central information treatment system for:
receiving information relating to events that are considered juridical;
receiving information relating to events considered extra modality legal;
receiving information that is competitor event related;
receiving information relating to events considered economic and/or commercial
whereby at least some events are key events,
said information treatment system determining for at least one of said event a compliance relating information selected from the group consisting of compliances and risks associated to compliance,
whereby the central information treatment system is linked at least to
a first database with data for mapping elements selected from a group consisting of products, services, components and combinations thereof, in various fields connected to said elements, whereby said fields are defined by at least one reference selected from the group consisting of words, portions thereof, abbreviations, phrases, portions thereof, paragraphs, sections, chapters, compounds thereof and combinations thereof;
a second database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third database comprising applicability hooks and the possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof,
in which the central treatment system uses data of the third database for linking at least one compliance of the second database relating to at least a portion of a field of an element of the first database, so that at least a portion of the reference attached to the linked compliance corresponds substantially to at least a portion of a risk conduit attached to the applicability hook, while at least a portion of the reference attached to the applicability hook corresponds substantially to a reference attached to the field of the element.

29. The management method of claim 28, in which the central treatment system uses data of the third database for determining applicability hook with a risk conduit having a reference corresponding substantially to a reference of another applicability hook.

30. The management method of claim 28, in which the first database incorporates data relating to at least one hooking parameter signalling at least whether a field of an element is linked to at least one applicability hook of the database.

31. The management method of claim 28, which comprises the step of adding information in at least one database, in at least one hypothesis selected from the group consisting of:
new mapping field of at least one element;
new compliance;
new risk conduits, and
new applicability hook.

32. The management method of claim 31, which comprises the step of requesting a skilled person intervention for defining the data to be added.

33. The management method of claim 31, which comprises computerized steps for helping a skilled person to add data.

34. The management method of claim 28, which comprises the step of adapting information in at least one database, in at least one hypothesis selected from the group consisting of:
new mapping field of at least one element;
new compliance;
new risk conduits, and
new applicability hook.

35. The management method of claim 34, which comprises the step of requesting a skilled person intervention for adapting the data.

36. The management method of claim 34, which comprises computerized steps for helping a skilled person to adapt data.

37. A management method providing selected information for taking at least one business decision faster and with less risk, relating to a company or a part thereof or one or more products or services or to one or more groups of products or services, said method comprising the step of using a at least partly computerized central information treatment system for:
receiving information relating to events that are considered juridical;
receiving information relating to events considered extra modality legal;
receiving information that is competitor event related;
receiving information relating to events considered economic and/or commercial
whereby at least some events are key events,
said information treatment system determining for at least one of said event a compliance relating information selected from the group consisting of compliances and risks associated to compliance,
whereby the central information treatment system is linked at least to:
a first database with data for mapping elements selected from a group consisting of products, services, components and combinations thereof, in various fields connected to said elements, whereby said fields are defined by at least one reference selected from the group consisting of words, portions thereof, abbreviations, phrases, portions thereof, paragraphs, sections, chapters, compounds thereof and combinations thereof;
a second database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third database comprising applicability hooks and possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof,
in which the central treatment system uses data of the third database for linking at least a portion of a field of an element of the first database relating to at least one compliance of the second database, so that at least a portion of the reference attached to the linked compliance corresponds substantially to at least a portion of a risk conduit attached to the applicability hook, while at least a portion of the reference attached to the applicability hook corresponds substantially to a reference attached to the field of the element.

38. The management method of claim 37, in which the central treatment system uses data of the third database for determining applicability hook with a risk conduit having a reference corresponding substantially to a reference of another applicability hook.

39. The management method of claim 37, in which the first database incorporates data relating to at least one hooking parameter signalling at least whether a field of an element is linked to at least one applicability hook of the database.

40. The management method of claim 37, which comprises the step of adding information in at least one database, in at least one hypothesis selected from the group consisting of:
new mapping field of at least one element;
new compliance;
new risk conduits, and
new applicability hook.

41. The management method of claim 40, which comprises the step of requesting a skilled person intervention for defining the data to be added.

42. The management method of claim 40, which comprises computerized steps for helping a skilled person to add data.

43. The management method of claim 37, which comprises the step of adapting information in at least one database, in at least one hypothesis selected from the group consisting of:
new mapping field of at least one element;
new compliance;
new risk conduits, and
new applicability hook.

44. The management method of claim 43, which comprises the step of requesting a skilled person intervention for adapting the data.

45. The management method of claim 43, which comprises computerized steps for helping a skilled person to adapt data.

46. A computerized machine having:
means for receiving information relating to events that are considered juridical;
means for receiving information relating to events considered extra modality legal;
means for receiving information that is competitor event related;
means for receiving information relating to events considered economic and/or commercial, and
means for treating said information for determining from said events at least one element selected from the group consisting of key events, impact assessments thereof, impact task management and combinations thereof, and editing at least one element selected from the group consisting of events, impact assessments, impact task management and combinations thereof, so as to enable at least one business decision to be taken more quickly and with less risk.

47. The machine of claim 46, said machine having at least one means selected from the group consisting of instruction codes for treating at least part of said information, means for reading instruction codes for treating at least part of said information, means for communicating with another machine comprising instruction codes for treating at least part of said information, and combinations thereof.

48. A computerized machine having:
means for receiving information relating to events that are considered juridical;
means for receiving information relating to events considered extra modality legal;
means for receiving information that is competitor event related;
means for receiving information relating to events considered economic and/or commercial, and
means for treating said information for determining from said events at least one element selected from the group consisting of key events, impact assessments thereof, impact task management and combinations thereof, and editing at least one element selected from the group consisting of events, impact assessments, impact task management and combinations thereof, so as to enable at least one business decision to be taken more quickly and with less risk.
whereby the central computer information treatment system is provided with instruction codes for linking said central computer information treatment system to at least the three following databases:
a first database with data mapping elements selected from the group selected from the group consisting of products, services, components and combinations thereof, various fields connected to said elements, whereby said fields are defined by at least one reference selected from the group consisting of words, portions thereof, abbreviations, phrases, portions thereof, paragraphs, sections, chapters, compounds thereof and combinations thereof;
a second database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third database group comprising applicability hooks and the possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof.

49. The machine of claim 48, in which the computer central system comprises instruction codes using data from the third database for linking at least one compliance of the second database relating to at least a portion of a field of an element of the first database, said instruction codes being such that at least a portion of the reference attached to the linking compliance corresponds substantially to at least a portion of a risk conduit attached to the applicability hook, while at least a portion of the reference attached to the applicability hook corresponds substantially to a reference linked to the field of the element.

50. The machine of claim 48, in which the central computer system comprises instruction codes using data of the third database for determining at least one applicability hook having a risk conduit having a reference corresponding substantially to a reference of another applicability hook.

51. The machine of claim 48, in which the central computer system comprises instruction codes for incorporating in the first database at least one hooking parameter signalling at least whether a field of an element is linked to at least one applicability hook of the third database.

52. The machine of claim 48, in which the central treatment system comprises instruction steps for adding information in at least one database, in at least one of hypothesis selected from the group consisting of:
new mapping field of at least one element;
new compliance;
new risk conduits;
new applicability hook.

53. The machine of claim 48, in which the central treatment system comprises instruction steps for adapting information in at least one database, in at least one of hypothesis selected from the group consisting of:
new mapping field of at least one element;
new compliance;
new risk conduits;
new applicability hook.

54. The machine of claim 48, comprising a central computer information treatment system comprises at least one of the databases selected from the group consisting of:
a first database with data for mapping elements selected from a group selected from the group consisting of products, services, components and combinations thereof, various fields connected to said elements, whereby said fields are defined by at least one reference selected from the group consisting of words, portions thereof, abbreviations, phrases, portions thereof, paragraphs, sections, chapters, compounds thereof and combinations thereof;
a second database comprising references to compliance selected from the group consisting of legal decisions, laws, rules, directives, court decisions, guidelines, codes, policies, draft, protocols, supra-legal compliance, supra-legal requirement, standards, whereby said references are selected from the group consisting of words, portions thereof, abbreviations, phrases, portions thereof, paragraphs, sections, chapters, compounds thereof and combinations thereof;
a third database comprising applicability hooks and the possible risk conduits attached thereto, whereby said applicability hooks are defined by at least a reference selected from the group consisting of words, portions thereof, abbreviations, phrases, portions thereof, paragraphs, sections, chapters, compounds thereof and combinations thereof, while the risk conduits are defined by at least a reference selected from the group consisting of words, portions thereof, abbreviations, phrases, portions thereof, paragraphs, sections, chapters, compounds thereof and combinations thereof,
while at least one of said databases is not comprised in the central computer information system,
whereby the central computer information system comprises instruction codes for linking the central computer information system to said at least one of said databases not comprised in the central computer information system.

55. The machine of claim 48, in which the computer central system comprises instruction codes using data from the third database for linking at least a portion of a field of an element of the first database relating to at least one compliance of the second database, said instruction codes being such that at least a portion of the reference attached to the linking compliance corresponds substantially to at least a portion of a risk conduit attached to the applicability hook, while at least a portion of the reference attached to the applicability hook corresponds substantially to a reference linked to the field of the element.
